(19) United States
(12) Patent Application Publication
(10) Pub. No.: US 2010/0289474 A1
(43) Pub. Date: Nov. 18, 2010

(54) CONTROLLERS FOR CONTROLLING POWER CONVERTERS

(76) Inventor: Ching-Chuan KUO, Taipei (TW)

Correspondence Address: PATENT PROSECUTION;O2MIRCO , INC., 3118 PATRICK HENRY DRIVE, SANTA CLARA, CA, 95054, US

(21) Appl. No.: 12/777,431

(22) Filed: May 11, 2010

Related U.S. Application Data
(60) Provisional application No. 61/177,745, filed on May 13, 2009.

(51) Int. Cl. G05F 1/10

(52) U.S. Cl. 323/284

(57) ABSTRACT

In one embodiment, a controller includes a first comparator, a second comparator and a control unit coupled to the first and second comparators. The first comparator is operable for comparing a first sense signal indicative of an output current flowing through an energy storage component of the power converter with a first threshold, and for generating a first comparison signal. The second comparator is operable for comparing a second sense signal indicative of the output current with a second threshold and for generating a second comparison signal. The control unit is operable for turning a switch of the power convertor on and off according to the first and second comparison signals. The energy storage component is coupled to a power source for storing energy from the power source if the switch is turned on, and is decoupled from the power source for releasing stored energy to a load if the switch is turned off.

### RELATED APPLICATION

This application claims priority to U.S. Provisional Application No. 61/177,745, entitled “Converters with Boundary Conduction Mode Control on Output Current,” filed on May 13, 2009, which is hereby incorporated by reference in its entirety.

### BACKGROUND

Switch-mode power converters such as DC-DC power converters convert an input voltage to a different output voltage. The switch-mode power converter includes a switch for coupling an energy storage component to a power source or decoupling the energy storage component from the power source, and a controller coupled to the switch for periodically turning the switch on and off. The energy storage component may be magnetic field storage components, e.g., inductors, transformers, or electric field storage components, e.g., capacitors. By adjusting a duty cycle of the switch, the amount of power transferred to the converter can be controlled.

Generally, the controller in a power converter, e.g., a buck converter, turns the switch on and off in a constant frequency mode or a constant off-time mode. However, the buck converter may not be able to control the load current properly when an input voltage of the converter varies in a relatively wide range, e.g., 85V-265V. Furthermore, for a buck converter or a flyback converter, to turn the switch on and off in a constant frequency mode or a constant off-time mode may cause larger switching loss and higher temperature on the switch when the input voltage is relatively high.

### SUMMARY

In one embodiment, a controller includes a first comparator, a second comparator and a control unit coupled to the first and second comparators. The first comparator is operable for comparing a first sense signal indicative of an output current flowing through an energy storage component of the power converter with a first threshold, and for generating a first comparison signal. The second comparator is operable for comparing a second sense signal indicative of the output current with a second threshold and for generating a second comparison signal. The control unit is operable for turning a switch of the power convertor on and off according to the first and second comparison signals. The energy storage component is coupled to a power source for storing energy from the power source if the switch is turned on, and is decoupled from the power source for releasing stored energy to a load if the switch is turned off.

In another embodiment, a controller includes a first sense pin, a second sense pin, an input pin, and a control pin. The first sense pin is operable for receiving a first sense signal indicative of an output current flowing through an energy storage component of the power converter. The second sense pin is operable for receiving a second sense signal indicative of the output current. The input pin is operable for receiving an input voltage of a power source provided to the power converter. The control pin is operable for sending a control signal to a switch coupled to the energy storage component to turning the switch on and off. In operation, the controller compares the first sense signal with a first threshold and generates a first comparison signal. The controller further compares the second sense signal with a second threshold and generates a second comparison signal. Furthermore, the controller generates the control signal to the switch via the control pin according to the first and second comparison signals.

In yet another embodiment, the power converter includes an energy storage component, a switch coupled to the energy storage component, and a controller coupled to the switch. The energy storage component is operable for storing energy from a power source and releasing stored energy to a load. The switch is operable for coupling the energy storage component to the power source and decoupling the energy storage component from the power source. The controller is operable for turning the switch on and off according to an output current flowing through the energy storage component to control the output current within a predetermined range. In operation, the controller turns on the switch to couple the energy storage component to the power source if the output current decreases lower than a first current threshold, and turns off the switch to decouple the energy storage component from the power source if the output current increases higher than a second current threshold.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1 illustrates a block diagram of a converter, in accordance with one embodiment of the present invention.

FIG. 2 illustrates waveforms of currents generated by the converter in FIG. 1, in accordance with one embodiment of the present invention.

FIG. 3 illustrates a block diagram of a controller for controlling a converter, in accordance with one embodiment of the present invention.

FIG. 4 illustrates a block diagram of a converter, in accordance with another embodiment of the present invention.

FIG. 5 illustrates waveforms of currents generated by the converter in FIG. 4, in accordance with one embodiment of the present invention.

FIG. 6 illustrates a block diagram of a controller for controlling a converter, in accordance with one embodiment of the present invention.

FIG. 7 is a flowchart of operations performed by a converter, in accordance with one embodiment of the present invention.

FIG. 8 is a flowchart of operations performed by a converter, in accordance with another embodiment of the present invention.

FIG. 9 illustrates a flowchart of a method for controlling an output current of a converter, in accordance with one embodiment of the present invention.

FIG. 10 illustrates a flowchart of a method for controlling an output current of a converter, in accordance with another embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide power converters and controllers for controlling the power converters. The controller controls a switch in the converter according to a current flowing through an energy storage component, e.g., an inductor or a transformer, in the converter. In one embodiment, if the current through the energy storage component decreases to a first threshold, the controller turns on the switch to couple the energy storage component to a power source. If the current through the energy storage component increases to a second threshold greater than the first threshold, the controller turns off the switch to decouple the energy storage component from the power source. The current though the energy storage component is controlled in a boundary conduction mode, i.e., the current through the energy storage component is within a predetermined range or between at least two predetermined boundaries. Advantageously, a current flowing through a load powered by the converter, which has a level equal to an average level of the current though the energy storage component, can remain substantially constant even if an input voltage varies in a relatively wide range, e.g., 85V-265V.

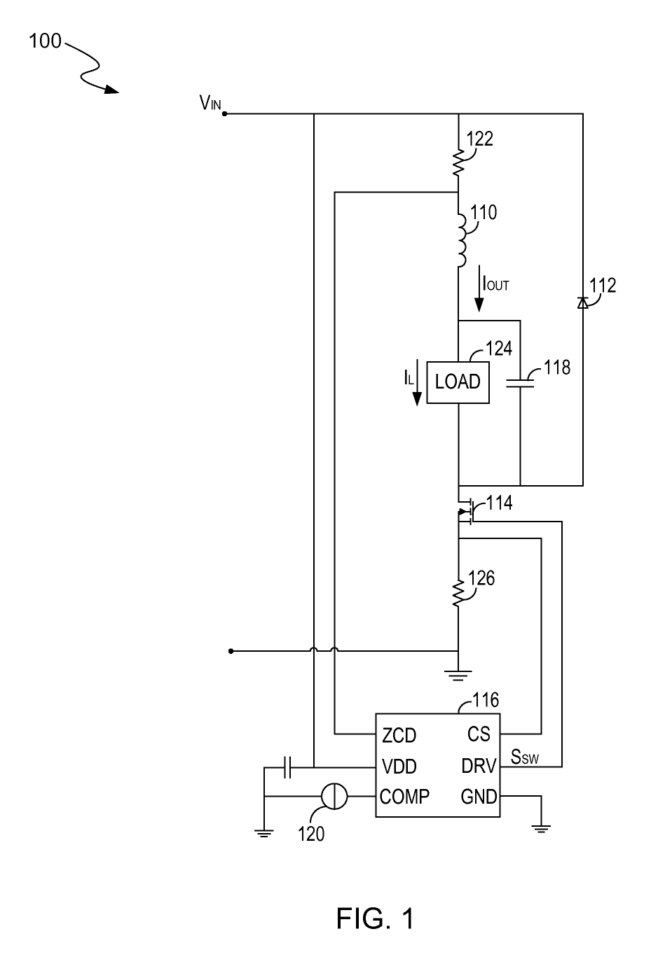

FIG. 1 illustrates a block diagram of a converter 100, e.g., a buck converter, in accordance with one embodiment of the present invention. The converter 100 includes an energy storage component for storing energy from a power source and discharging the stored energy to a load 124. In the example of FIG. 1, the energy storage component includes an inductor 110. A resistor 122, the inductor 110, the load 124, a switch 114, and a resistor 126 are coupled between a power source and ground in series. A diode 112 is coupled to the resistor 122, the inductor 110, and the load 124 in parallel. A capacitor 118 is coupled to the load 124 in parallel for filtering ripples of an output current I_{OUT} flowing through the inductor 110 to the load 124. As such, a current I_{L} flowing though the load 124 is a direct current. The switch 114 is used to electrically couple the inductor 110 to the power source or decouple the inductor 110 from the power source. When the switch 114 is turned on, the output current I_{OUT} flows from the power source to the load 124 through the inductor 110, the switch 114, and the resistor 126. Energy can be stored in the inductor 110 temporarily. When the switch 114 is turned off, energy stored in the inductor 110 is discharged from the inductor 110 to the load 124. The current I_{L} flowing through the load 124 thus has a level equal to an average level of the output current I_{OUT}.

The converter 100 further includes a controller 116 coupled to the switch 114 for controlling the switch 114 to regulate the output current I_{OUT} in order to keep the current I_{L} through the load 124 substantially constant. In one embodiment, the controller 116 is an integrated circuit having pins ZCD, CS, VDD, DRV, COMP, and GND. The pin ZCD is coupled to the resistor 122 and the inductor 110. The input voltage V_{IN} is provided to the controller 116 via the pin VDD. In the example of FIG. 1, the controller 112 monitors the output current I_{OUT} through the inductor 110 by sensing a sense signal V_{IN-ZCD} representing a difference between the input voltage V_{IN} at the pin VDD and the voltage V_{ZCD} at the pin ZCD. A voltage source 120 coupled to the pin COMP is used to provide a voltage threshold V_{THR2} to the controller 116. The pin CS is coupled to the switch 114 and the resistor 126. The controller 112 also monitors the output current I_{OUT} through the inductor 110 by sensing a sense signal V_{CS} at the pin CS, which represents a voltage V₁₂₆ across the resistor 126. The pin DRV is coupled to the switch 114. The controller 116 generates a control signal S_{SW} to the switch 114 via the pin DRV for controlling the switch 114. In one embodiment, the controller 116 generates the control signal S_{SW} in a first state to turn on the switch 114, and generates the control signal S_{SW} in a second state to turn off the switch 114. The pin GND is coupled to ground.

In operation, if the input voltage V_{IN} at the pin VDD is higher than a start-up voltage, e.g., 13V, the controller 116 starts to operate. Otherwise, the controller 116 is disabled and consequently the switch 114 is turned off. If the controller 116 is enabled, the controller 116 generates the control signal S_{SW} in the first state to turn on the switch 114 via the pin DRV. The inductor 110 is coupled to the input voltage V_{IN}. As such, the output current I_{OUT} flowing from the power source to the load 124 through the resistor 126 can gradually increase from zero, which results in an increase of the voltage V₁₂₆. Energy is stored in the inductor 110 temporarily.

When the switch 114 is turned on, the voltage across the resistor 122 may not vary with respect to the output current I_{OUT} simultaneously because of hysteresis of the inductor 110. As such, the controller 116 can monitor the output current I_{OUT} by sensing the sense signal V_{CS} at the pin CS, which represents the voltage V₁₂₆ across the resistor 126. When the sense signal V_{CS} increases higher than the voltage threshold V_{THR2}, which indicates that the output current I_{OUT} through the inductor 110 increases higher than a current threshold I_{THR2}, the controller 116 generates the control signal S_{SW} in the second state to turn off the switch 114 via the pin DRV. The inductor 110 is decoupled from the power source. Thus, the energy stored in the inductor 110 is discharged from the inductor 110 to the load 124. The output current I_{OUT} flows from the inductor 110 to the load 124 through the diode 112 and the resistor 122, and gradually decreases to zero.

When the switch 114 is turned off, the controller 112 can monitor the output current I_{OUT} by sensing the sense signal V_{IN-ZCD} representing the difference between the input voltage V_{IN} at the pin VDD and the voltage V_{ZCD} at the pin ZCD. When the sense signal V_{IN-ZCD} decreases less than a voltage threshold V_{THR1}, e.g., 0.1V, which indicates the output current I_{OUT} through the inductor 110 decreases lower than a current threshold I_{THR1}, e.g., approximately zero, the controller 116 generates the control signal S_{SW} in the first state to turn on the switch 114 via the pin DRV. The output current I_{OUT} flowing from the power source to the load 124 through the switch 114 and the resistor 126 then gradually increases, which results in an increase of the voltage V₁₂₆. As used herein, “approximately zero” means that the output current I_{OUT} may be different from zero so long as a ripple current through the inductor 110 when the switch 114 is off is relatively small and can be omitted.

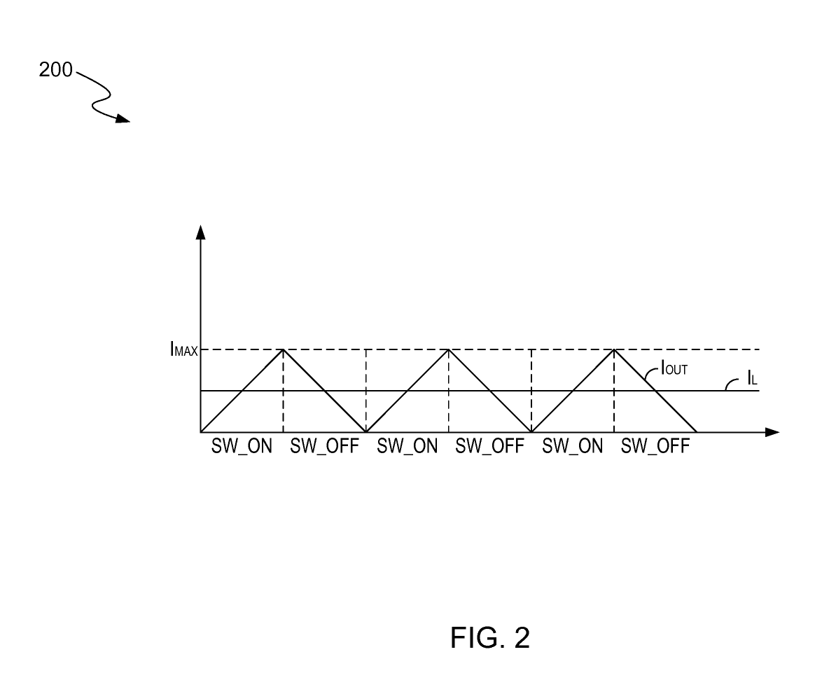

FIG. 2 shows waveforms of the output current I_{OUT} and the load current I_{L} generated by the converter 100 in FIG. 1, in accordance with one embodiment of the present invention. As shown in FIG. 2, the output current I_{OUT} periodically increases from zero to a maximum value I_{MAX} during a period SW_ON when the switch 114 is turned on, and decreases from the maximum value I_{MAX} to approximately zero during a period SW_OFF when the switch 114 is turned off. The current I_{L} remains substantially constant during the periods SW_ON and SW_OFF. As such, the output current I_{OUT} can be controlled within a predetermined range, e.g., between a minimum value (e.g., zero) and a maximum value I_{MAX}. The maximum value I_{MAX} can be given by equation (1).

I_{MAX}=V_{126(MAX)}/R₁₂₆=V_{THR1}/R₁₂₆ (1)

R₁₂₆ represents resistance of the resistor 126.

The average level I_{AVG} of the output current I_{OUT}, which is approximately equal to the load current I_{L}, can be given by equation (2).

I_{AVG}=I_{L}=0.5*I_{MAX}=0.5*(V_{THR1}/R₁₂₆) (2)

Advantageously, to control the on and off states of the switch 114 according to the output current I_{OUT} flowing through the inductor 110, the output current I_{OUT} can be controlled within a predetermined range. As such, according to equation (2), the current I_{L} flowing through the load 124 can remain substantially constant even if the input voltage varies in a relatively wide range, e.g., 85V-265V. Furthermore, when the switch 114 is turned on, a voltage drop across the switch 114 can be approximately zero since the output current I_{OUT} flowing through the switch 114 is approximately zero. As such, a quasi-zero voltage switching can be achieved. Thus, the switching loss and temperature of the switch 114 can be reduced.

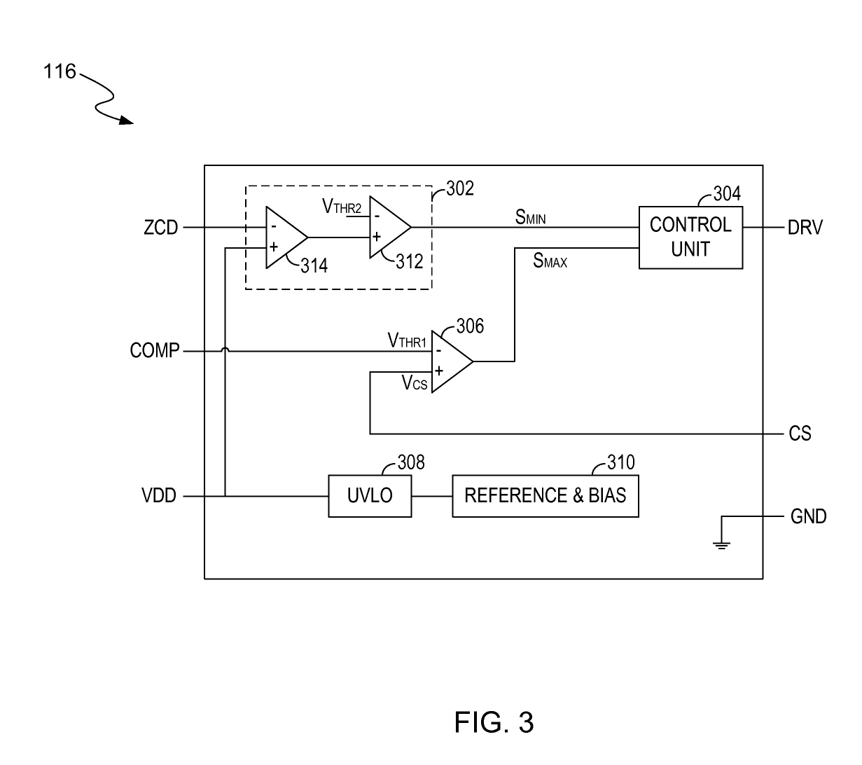

FIG. 3 illustrates a block diagram of the controller 116 in FIG. 1, in accordance with one embodiment of the present invention. FIG. 3 is described in combination with FIG. 1. In one embodiment, the controller 116 is used to control a direct current to direct current (DC/DC) converter, e.g., buck converter. However, the invention is not so limited, the controller 116 can also be used in other types of converters, e.g., alternating current to direct current (AC/DC) converter or direct current to alternating current (DC/AC) converter.

In the controller 116, the voltage V_{VDD} at the pin VDD is supplied to a reference and bias unit 310 via an under-voltage lockout unit 308. If the voltage V_{VDD} is higher than a start-up voltage, e.g., 13V, the reference and bias unit 310 can generate an operating voltage, e.g., 5V, to function units in the controller 116, such as a current detector 302, a control unit 304, and a comparator 306. As such, the controller 116 is enabled. If the voltage V_{VDD} is no greater than the start-up voltage, the under-voltage lockout unit 308 can block the voltage V_{VDD} and the reference and bias unit 310 is disabled. Consequently, the controller 116 is disabled.

The current detector 302 is operable for detecting the output current I_{OUT} through the inductor 110 by sensing a sense signal V_{IN-ZCD} representing a difference between the voltage V_{IN} at the pin VDD and the voltage V_{ZCD} at the pin ZCD. In the example of FIG. 3, the current detector 302 includes an amplifier 314 for receiving the voltage V_{ZCD} at the pin ZCD and the input voltage V_{IN} at the pin VDD, and generating the sense signal V_{IN-ZCD} representing the difference between the voltage V_{IN} and the voltage V_{ZCD}. The difference between the voltage V_{IN} and the voltage V_{ZCD} is proportional to the output current I_{OUT}. The current detector 302 further includes a comparator 312 for comparing the sense signal V_{IN-ZCD} with a voltage threshold V_{THR1}, and generating a signal S_{MIN} (e.g., having a low level) if the signal V_{IN-ZCD} is less than the voltage threshold V_{THR1}.

In one embodiment, when the signal V_{IN-ZCD} decreases less than the voltage threshold V_{THR1}, which indicates that the output current I_{OUT} decreases lower than a current threshold I_{THR1}, the comparator 312 generates the signal S_{MIN} to the control unit 304. In response to the signal S_{MIN}, the control unit 304 generates the control signal S_{SW} in the first state to turn on the switch 114 via the pin DRV.

The comparator 306 further monitors the output current I_{OUT} through the inductor 110 by sensing a sense signal V_{CS} at the pin CS representing a voltage V₁₂₆ across the resistor 126. In one embodiment, the comparator 306 compares the sense signal V_{CS} with the voltage threshold V_{THR2} and generates a signal S_{MAX} (e.g., having a high level) if the sense signal V_{CS} increases higher than the voltage threshold V_{THR2}. The voltage threshold V_{THR2} is provided by a voltage source, e.g., the voltage source 120, via the pin COMP. In response to the signal S_{MAX}, the control unit 304 generates the control signal S_{SW} in the second state to turn off the switch 114 via the pin DRV.

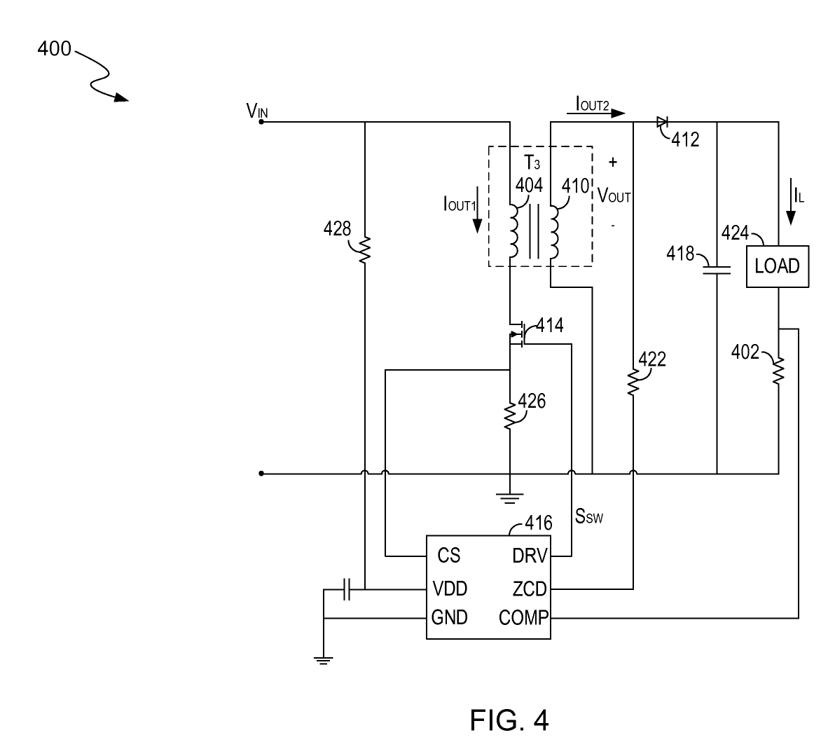

FIG. 4 illustrates a block diagram of a converter 400, e.g., a flyback converter, in accordance with one embodiment of the present invention. The converter 400 includes an energy storage component for storing energy from a power source and discharging the stored energy to a load 424. In one embodiment, the energy storage component can be a transformer T₃ with a primary winding 404 and a secondary winding 410. The primary winding 404, a switch 414, and a resistor 426 are coupled between the power source and ground in series. A diode 412, the load 424, and a resistor 402 are coupled to the secondary winding 410 in series. A capacitor 418 is coupled to the load 424 and the resistor 402 in parallel for filtering ripples of an output current I_{OUT2} flowing from the secondary winding 410 to the load 424 and the resistor 402. As such, a current I_{L} flowing through the load 424 and the resistor 402 is a direct current.

In one embodiment, when the switch 414 is turned on, the primary winding 404 is coupled to the power source. As such, energy can be accumulated in the transformer T₃. Since the voltage across the secondary winding 410 is negative, the diode 412 is reverse-biased. Thus, no current flows through the load 424. When the switch 414 is turned off, the primary winding 404 is decoupled from the power source. Under this circumstance, the voltage across the secondary winding 410 becomes positive. Thus, the diode 412 is forward-biased. As a result, energy stored in the transformer T₃ is transferred from the secondary winding 410 to the load 424. The output current I_{OUT2} flows through the secondary winding 410 and the diode 412 to the load 424. The current I_{L} flowing though the load 424 and the resistor 402 thus has a level equal to an average level of the output current I_{OUT2}.

The converter 400 further includes a controller 416 coupled to the switch 414 for controlling the switch 414 to regulate the output current I_{OUT2} in order to keep the current I_{L} through the load 424 substantially constant. In one embodiment, the controller 416 is an integrated circuit having pins ZCD, CS, VDD, DRV, COMP, and GND. The pin VDD can be coupled to the power source through a resistor 428. The pin GND is coupled to ground. The pin DRV is coupled to the switch 414. The controller 416 controls the switch 414 via the pin DRV. In one embodiment, the controller 116 generates a control signal S_{SW} in a first state to the switch 414 via the pin DRV to turn on the switch 114, and generates the control signal S_{SW} in a second state to the switch 414 via the pin DRV to turn off the switch 114. Furthermore, the pin ZCD is coupled to the secondary winding 410 and the diode 412 through a resistor 422. The controller 416 monitors the output current I_{OUT2} through the secondary winding 410 of the transformer T₃ by sensing a sense signal V_{ZCD} at the pin ZCD, which represents an output voltage V_{OUT} across the secondary winding 410.

Additionally, the pin CS is coupled to the switch 414 and the resistor 426. A sense signal V_{CS} sensed at the pin CS represents a voltage V₄₂₆ across the resistor 426. The controller 416 monitors an output current I_{OUT1} through the primary winding 404 of the transformer T₃ by sensing the sense signal V_{CS} at the pin CS. The pin COMP is coupled to the load 424 and the resistor 402 for monitoring the voltage V₄₀₂ across the resistor 402, which indicates the load current I_{L}. The controller 416 generates a voltage threshold V_{THR2} based on the voltage V₄₀₂ sensed at the pin COMP. More specifically, if the voltage V₄₀₂ increases higher than a predetermined value V_{PRE}, e.g., 0.25V, the voltage threshold V_{THR2} can decrease accordingly. If the voltage V₄₀₂ decreases lower than the predetermined value V_{PRE}, the voltage threshold V_{THR2} can increase accordingly. If the voltage V₄₀₂ is approximately zero, the voltage threshold V_{THR2} can increase to a predetermined maximum value V_{MAX}, e.g., 3.5V. In other words, the voltage threshold V_{THR2} can be adjusted according to a comparison between the voltage V₄₀₂ and the predetermined value V_{PRE}. In one embodiment, the predetermined value V_{PRE} can be set by a user. As described above, the voltage V₄₀₂ is proportional to the load current I_{L}. Thus, the voltage threshold V_{THR2} is adjusted according a comparison result between the load current I_{L} and a predetermined value I_{PRE}.

When an input voltage is provided to the converter 400, if a voltage V_{VDD} at the pin VDD is higher than a start-up voltage, e.g., 13V, the controller 416 is enabled. Otherwise, the controller 416 is disabled and the switch 414 is turned off. When the controller 416 is enabled, the controller 416 can turn on the switch 414 via the pin DRV. The primary winding 404 is coupled to the power source. As such, the output current I_{OUT1} flowing through the primary winding 404, the switch 414 and the resistor 426 can gradually increase from zero, and the voltage V₄₂₆ across the resistor 426 can gradually increase from zero. The energy is accumulated in the transformer T₃ and no current flows through the load 424.

Since the voltage V₄₀₂ across the resistor 402 is zero at start-up, the voltage threshold V_{THR2} is at the predetermined maximum value V_{MAX}. The controller 416 monitors the output current I_{OUT1} by sensing the sense signal V_{CS} at the pin CS. If the sense signal V_{CS} representing the voltage V₄₂₆ increases higher than the voltage threshold V_{THR2}, which indicates that the output current I_{OUT1} increases higher than a current threshold I_{THR1}, the controller 416 generates the control signal S_{SW} in the second state to turn off the switch 414 via the pin DRV. As such, the primary winding 404 is decoupled from the power source. Energy stored in the transformer T₃ is transferred to the load 424. The output current I_{OUT2} flowing from the secondary winding 410 to the load 424 and the resistor 402 through the diode 412 can increase to a maximum value and then gradually decrease to a minimum value, e.g., approximately zero.

When the switch is turned off, the controller 416 monitors the output current I_{OUT2} by sensing the sense signal V_{ZCD} at the pin ZCD. If the sense signal V_{ZCD} decreases less than the voltage threshold V_{THR1}, which indicates that the output current I_{OUT2} decreases lower than the current threshold I_{THR2}, the controller 416 generates the control signal S_{SW} in the first state to turn on the switch 414 via the pin DRV. The primary winding 404 is coupled to the power source. Thus, the output current I_{OUT1} flowing through the primary winding 404 can gradually increase from zero. Additionally, when the switch 414 is turned on, the voltage across the secondary winding 410 can drop down to a minimum value, e.g., approximately zero. Similarly, the voltage V₄₀₄ across the primary winding 404 can also drop down to the minimum value. As such, a drain voltage of the switch 414, which is approximately equal to a summation of V_{IN} and V₄₀₄, can drop down to a minimum value. As such, the power dissipation and temperature of the switch 414 can be reduced.

During the operation, if the voltage V₄₀₂ increases higher than the predetermined value V_{PRE}, the voltage threshold V_{THR2} can decrease accordingly. Thus, the maximum value of the sense signal V_{CS} at the pin CS can decrease, which results in a decrease of the energy stored in the transformer T₃. Consequently, the current I_{L} flowing through the load 424 and the resistor 402 decreases, which results in a decrease of the voltage V₄₀₂. If the voltage V₄₀₂ decreases lower than the predetermined value V_{PRE}, the voltage threshold V_{THR2} can increase accordingly. As such, the maximum value of the sense signal V_{CS} at the pin CS can increase, which results in an increase of the energy stored in the transformer T₃. Consequently, the current I_{L} flowing through the load 424 and the resistor 402 increases, which results in an increase of the voltage V₄₀₂.

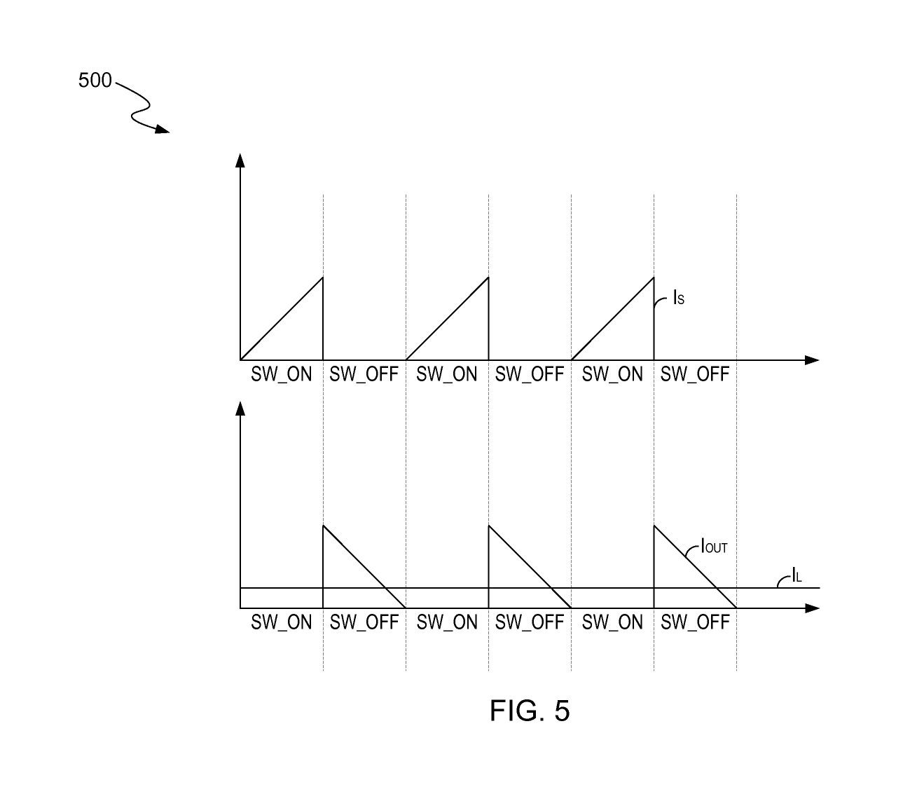

FIG. 5 shows waveforms of currents generated by the converter 400, e.g., the output current I_{OUT1} flowing through the primary winding 404, the output current I_{OUT2} flowing through the secondary winding 410, and the current I_{L} flowing through the load 424, in accordance with one embodiment of the present invention.

As shown in FIG. 5, the output current I_{OUT1} increases from zero to a maximum value during a period SW_ON when the switch 414 is turned on. The output current I_{OUT1} falls to approximately zero and remains substantially zero during a period SW_OFF when the switch 414 is turned off. The output current I_{OUT2} remains substantially zero during the period SW_ON. The output current I_{OUT2} decreases from a maximum value to approximately zero during the period SW_OFF. The current I_{L} remains substantially constant during the periods SW_ON and SW_OFF. Since the voltage V₄₀₂ can be controlled around the predetermined value V_{PRE}, the current I_{L} can be controlled around a value I_{AVG} which can be given by equation (3).

I_{AVG}=V_{PRE}/R₄₀₂ (3)

R₄₀₂ represents resistance of the resistor 402.

Advantageously, the converter 400 can control the output current I_{OUT2} within a predetermined range. According to equation (3), the current I_{L} flowing through the load 424 can remain substantially constant even if the input voltage varies in a relatively wide range, e.g., 85V-265V. Furthermore, the current I_{L} can be regulated by adjusting the resistance of the resistor 402. Similar to the converter 100 in FIG. 1, when the switch 414 is turned on, the drain voltage of the switch 414 can drop down to a minimum value. As such, the power dissipation and temperature of the switch 414 can be reduced.

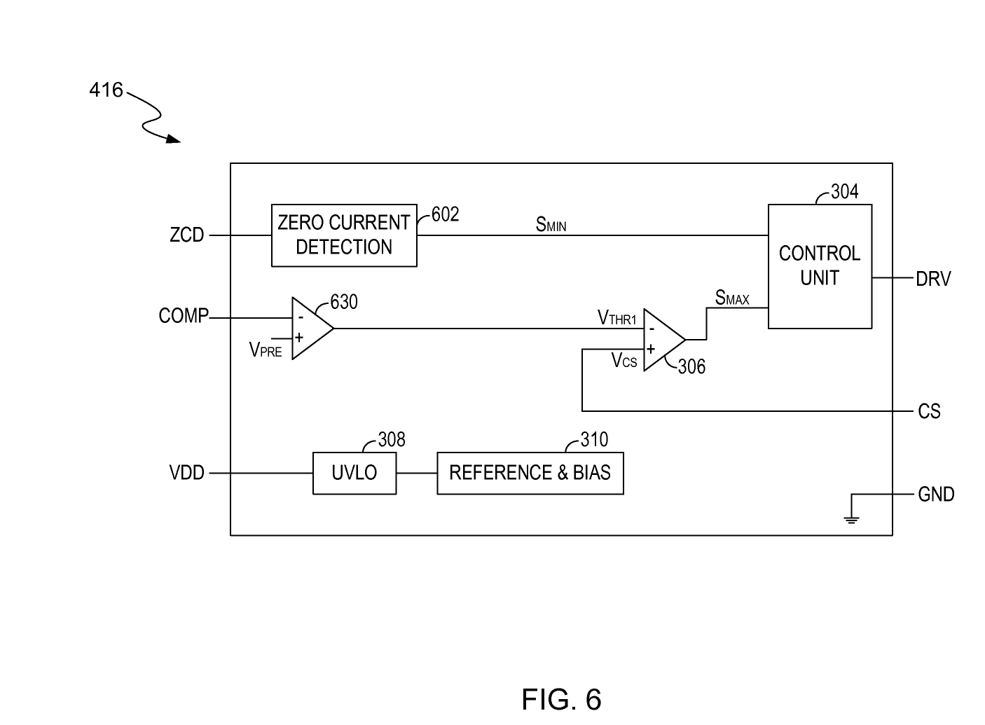

FIG. 6 illustrates a block diagram of the controller 416 in FIG. 4, in accordance with one embodiment of the present invention. Elements that are labeled the same as in FIG. 3 have similar functions and will not be detailed described herein. FIG. 6 is described in combination with FIG. 3 and FIG. 4. In one embodiment, the controller 416 is used to control a direct current to direct current (DC/DC) converter. However, the invention is not so limited; the controller 416 can be also used to other types of converters, e.g., an alternating current to direct current (AC/DC) converter or a direct current to alternating current (DC/AC) converter.

In the example of FIG. 6, the controller 416 includes a current detector 602 coupled to the pin ZCD to monitor the output current I_{OUT2} by sensing the sense signal V_{ZCD} at the pin ZCD. In one embodiment, the current detector 602 is falling edge triggered if the sense signal V_{ZCD} decreases lower than the voltage threshold V_{THR1}. In response, the current detector 602 generates a signal S_{MIN} (e.g., having a low level) to the control unit 304. In response to the signal S_{MIN}, the control unit 304 turns on the switch 414 via the pin DRV.

The controller 416 further includes an error amplifier 630 for comparing the voltage V₄₀₂ at the pin COMP with a predetermined value V_{PRE}, and generating the voltage threshold V_{THR2} according to the comparison result. If the voltage V₄₀₂ increases higher than the predetermined value V_{PRE}, the voltage threshold V_{THR2} decreases accordingly. If the voltage V₄₀₂ decreases lower than the predetermined value V_{PRE}, the voltage threshold V_{THR2} increases accordingly. If the voltage V₄₀₂ is approximately zero, the voltage threshold V_{THR2} can increase to a predetermined maximum value V_{MAX}, e.g., 3.5V. In other words, the voltage threshold V_{THR2} can be adjusted according to a comparison between the voltage V₄₀₂ and the predetermined value V_{PRE}. In one embodiment, the predetermined value V_{PRE} can be set by a user. The comparator 306 compares the sense signal V_{CS} at the pin CS with the voltage threshold V_{THR2}, and generates a signal S_{MAX} (e.g., having a high level) to the control unit 304 if the sense signal V_{CS} increases higher than the voltage threshold V_{THR2}. In response to the signal S_{MAX}, the control unit 304 turns off the switch 414.

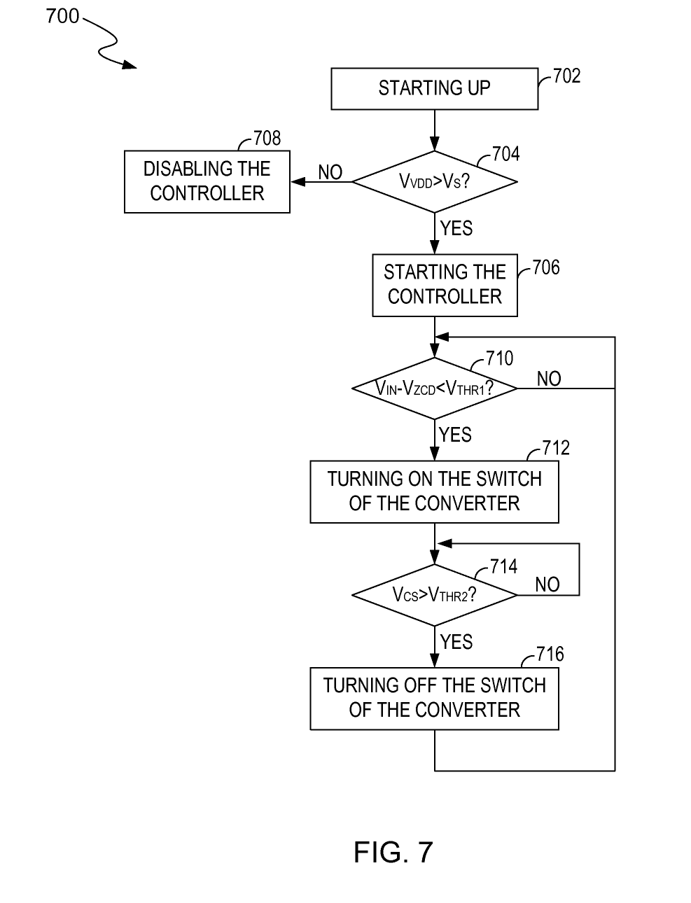

FIG. 7 is a flowchart 700 of operations performed by a converter, e.g., the converter 100 in FIG. 1, in accordance with one embodiment of the present invention. FIG. 7 is described in combination with FIG. 1 and FIG. 3.

The converter 100 starts up in block 702. If the voltage V_{VDD} provided to the controller 116 is higher than a start-up voltage V_{S}, e.g., 13V, in block 704, the reference and bias unit 310 in the controller 116 generates an operating voltage, e.g., 5V, to the function units in the controller 116, such as the current detector 302, the control unit 304, and the comparator 306. As such, the controller 116 starts to operate in block 706. If the voltage V_{VDD} is lower than the start-up voltage V_{S}, the controller 116 is disabled in block 708.

In block 710, if the sense signal V_{IN-ZCD} representing the difference between the input voltage V_{IN} at the pin VDD and the voltage V_{ZCD} at the pin ZCD is not lower than the voltage threshold V_{THR1}, e.g., 0.1V, the switch 114 remains off. Once the sense signal V_{IN-ZCD} is lower than the voltage threshold V_{THR1}, the current detector 302 generates a signal S_{MIN} (e.g., having a low level) to the control unit 304 in the controller 116. The difference between the input voltage V_{IN} and the voltage V_{ZCD} is proportional to the output current I_{OUT}. In response to the signal S_{MIN}, the control unit 304 turns on the switch 114 via the pin DRV in block 712. The output current I_{OUT} gradually increases from zero.

In block 714, if the sense signal V_{CS} at the pin CS is not higher than the voltage threshold V_{THR2}, the switch 114 remains on. Once the sense signal V_{CS} at the pin CS increases higher than the voltage threshold V_{THR2}, the comparator 306 generates a signal S_{MAX} (e.g., having a high level) to the control unit 304. The sense signal V_{CS} is proportional to the output current I_{OUT}. In response to the signal S_{MAX}, the control unit 304 turns off the switch 114 via the pin DRV in block 716. The output current I_{OUT} gradually decreases from the maximum value to zero. After the switch 114 is turned off in block 716, the flowchart 700 returns to block 710.

As a result, the output current I_{OUT} flowing through the inductor 110 to the load 124 periodically increases from zero to a maximum value I_{MAX} and decreases from the maximum value I_{MAX} to zero. As such, the output current I_{OUT} can be controlled within a predetermined range. Advantageously, the current I_{L} flowing through the load 124 can remain substantially constant even if the input voltage varies in a relatively wide range, e.g., 85V-265V.

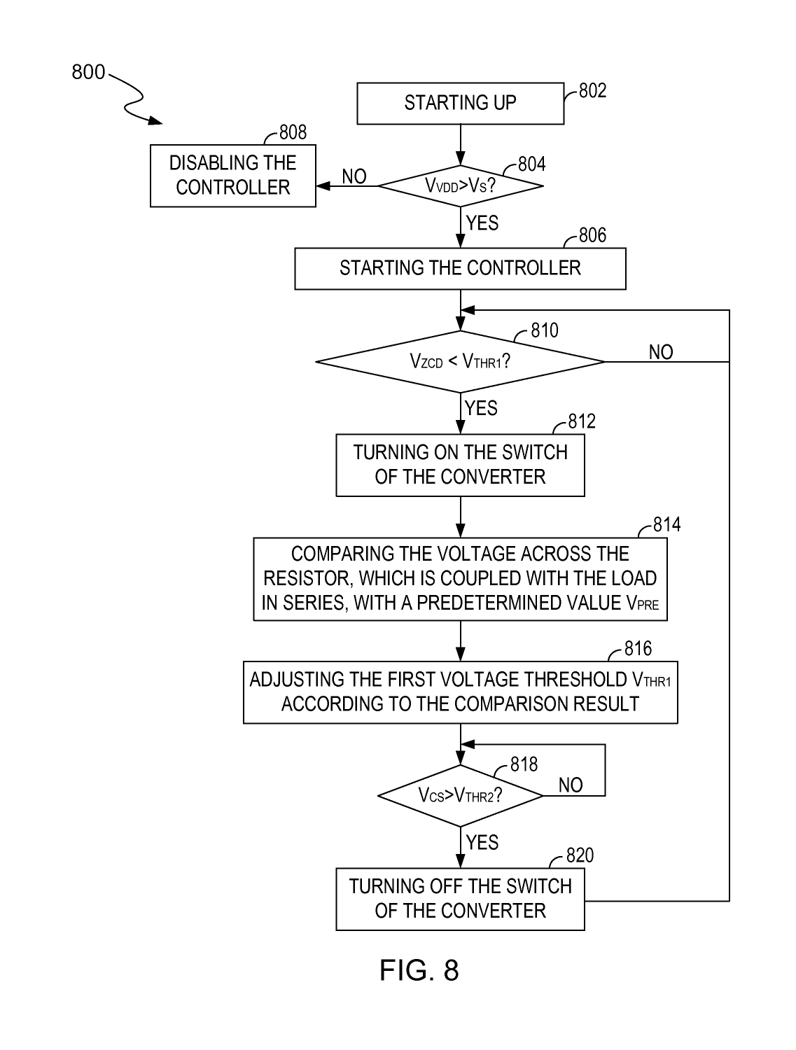

FIG. 8 is a flowchart 800 of operations performed by a converter, e.g., the converter 400 in FIG. 4, in accordance with one embodiment of the present invention. FIG. 8 is described in combination with FIG. 4 and FIG. 6.

The converter 400 starts up in block 802. If the voltage V_{VDD} provided to the controller 416 is higher than a start-up voltage V_{S}, e.g., 13V, in block 804, the reference and bias unit 310 generates an operating voltage, e.g., 5V, to the function units in the controller 416, such as the current detector 602, the control unit 304, the error amplifier 630, and the comparator 306. As such, the controller 416 is enabled to operate in block 806. If the voltage V_{VDD} is lower than the start-up voltage V_{S}, the controller 416 is disabled in block 808.

In block 810, if the sense signal V_{ZCD} at the pin ZCD is not lower than the voltage threshold V_{THR1}, e.g., 0.1v, the switch 414 remains off. Once the sense signal V_{ZCD} decreases lower than the voltage threshold V_{THR1}, which indicates that the output current I_{OUT2} decreases lower than the current threshold I_{THR2}, the current detector 602 generates a signal S_{MIN} (e.g., having a low level) to the control unit 304. In response to the signal S_{MIN}, the control unit 304 turns on the switch 414 via the pin DRV in block 812. The output current I_{OUT1} flowing through the primary winding 404 gradually increases from zero. Since the voltage across the secondary winding 410 is negative, the diode 412 is reverse-biased. As such, no current flows through the secondary winding 410 to the load 424.

In block 814, the error amplifier 630 compares the voltage V₄₀₂ of the resistor 402 with a predetermined value V_{PRE} and generates the voltage threshold V_{THR2} according to the comparison result. In block 816, the error amplifier 630 adjusts the voltage threshold V_{THR2} according to the comparison result. If the voltage V₄₀₂ increases higher than the predetermined value V_{PRE}, the error amplifier 630 decreases the voltage threshold V_{THR2} accordingly. If the voltage V₄₀₂ decreases lower than the predetermined value V_{PRE}, the error amplifier 630 increases the voltage threshold V_{THR2} accordingly. If the voltage V₄₀₂ is approximately zero, the voltage threshold V_{THR2} is set to a predetermined maximum value V_{MAX}, e.g., 3.5V.

In block 818, if the sense signal V_{CS} at the pin CS is no higher than the voltage threshold V_{THR2}, the switch 414 remains on. Once the sense signal V_{CS} at the pin CS increases higher than the voltage threshold V_{THR2}, which indicates the output current I_{OUT1} through the primary winding 404 of the transformer T₃ increases higher than the current threshold I_{THR1}, the comparator 306 generates a signal S_{MAX} (e.g., having a high level) to the control unit 304. The sense signal V_{CS} is proportional to the output current I_{OUT1} flowing through the primary winding 404. In response to the signal S_{MAX}, the control unit 304 turns off the switch 414 via the pin DRV in block 820. Since the voltage across the secondary winding 410 becomes positive, the diode 412 is forward-biased. As such, energy stored in the transformer T₃ can be transferred to the load 424. The output current I_{OUT2} flowing from the secondary winding 410 to the load 424 through the diode 412 rises to a maximum value and then gradually decreases to zero. After the switch 414 being turned off in block 820, the flowchart 800 returns to block 810.

Advantageously, the converter 400 can adjust the voltage threshold V_{THR2} according to the comparison between the voltage V₄₀₂ of the resistor 402 and the predetermined value V_{PRE}. As such, the voltage V₄₀₂ of the resistor 402 can be controlled around the predetermined value V_{PRE} and the output current I_{OUT2} can be controlled within a predetermined range. Therefore, the current I_{L} can be controlled around a certain level even if the input voltage varies in a relatively wide range, e.g., 85V-265V.

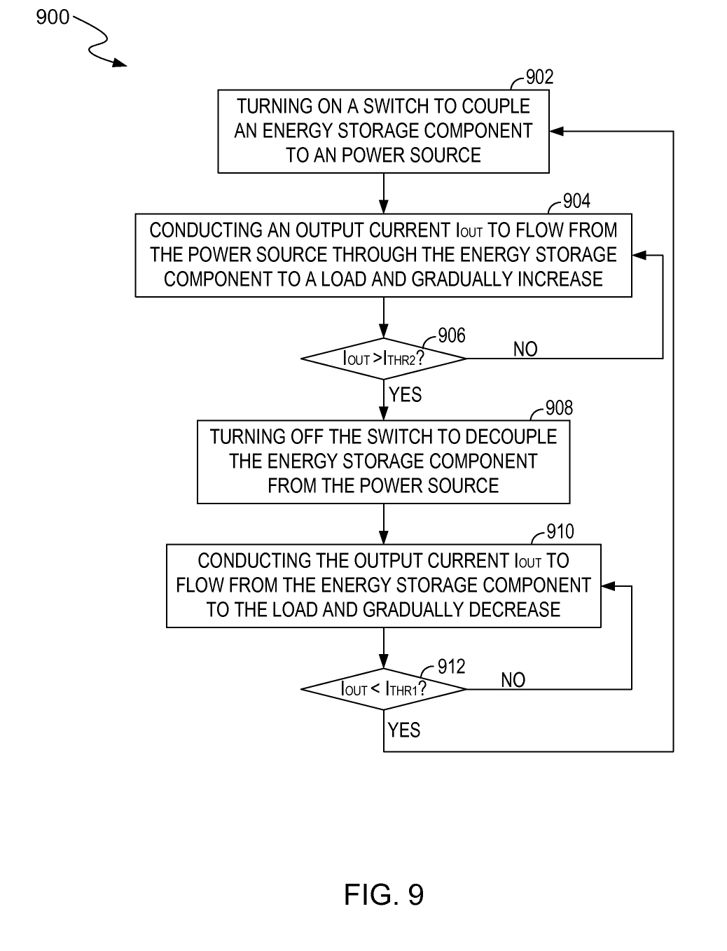

FIG. 9 illustrates a flowchart 900 of a method for controlling an output current of a converter, e.g., the converter 100 in FIG. 1, in accordance with one embodiment of the present invention. FIG. 9 is described in combination with FIG. 1.

After the converter 100 is powered on, the switch 114 is turned on by a controller, e.g., the controller 116, to electrically couple an energy storage component, e.g., the inductor 110, to a power source, in block 902. As such, an output current I_{OUT} is conducted to flow from the power source through the energy storage component to a load and gradually increases, in block 904. Energy is be accumulated in the energy storage component.

In block 906, if the output current I_{OUT} is not higher than a current threshold I_{THR2}, the switch 114 remains on. Once the output current I_{OUT} increases higher than the current threshold I_{THR2} in block 906, the controller 116 turns off the switch 114 to decouple the energy storage component from the power source, in block 908. As such, the output current I_{OUT} is conducted to flow from the energy storage component to the load and gradually decreases in block 910. Energy stored in the energy storage component is transferred to the load.

In block 912, if the output current I_{OUT} is not lower than a current threshold I_{THR1}, the switch 114 remains off. Once the output current I_{OUT} decreases lower than the current threshold I_{THR1} in block 912, flowchart 900 returns to block 902 and the controller 116 turns on the switch 114 to couple the energy storage component to the power source. As such, the output current I_{OUT} is conducted to flow through the energy storage component to the load and gradually increases.

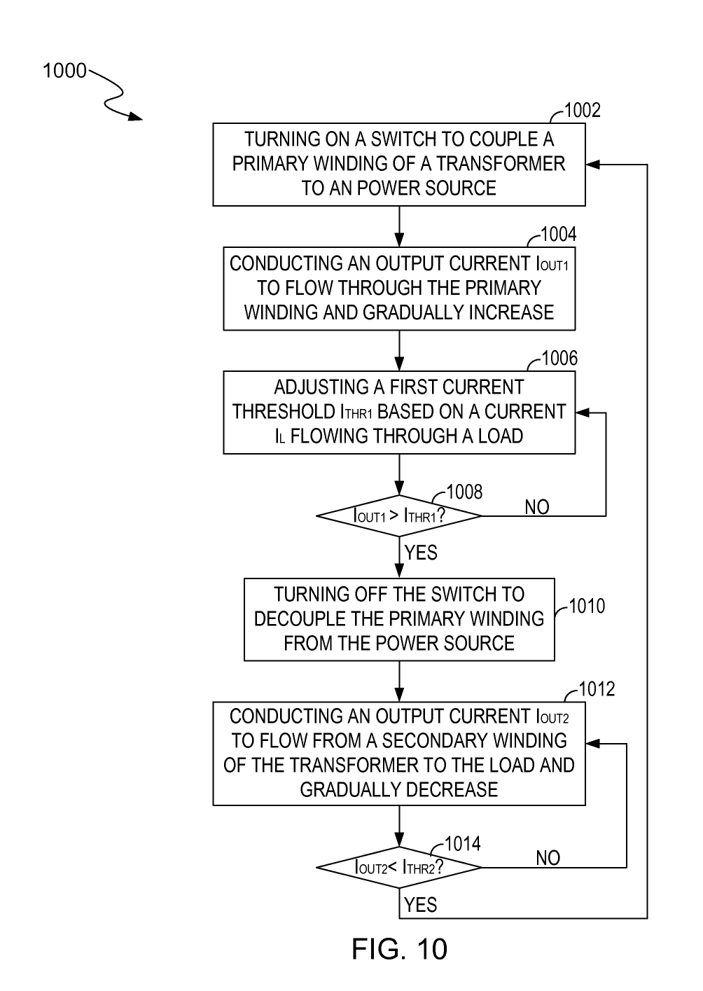

FIG. 10 illustrates a flowchart 1000 of a method for controlling an output current of a converter, e.g., the converter 400 in FIG. 4, in accordance with one embodiment of the present invention. FIG. 10 is described in combination with FIG. 4.

After the converter 400 is powered on, the switch 414 is turned on by a controller, e.g., the controller 416, to electrically couple an energy storage component, e.g., the primary winding 404 of the transformer T₃, to a power source in block 1002. As such, an output current I_{OUT1} is conducted to flow through the primary winding 404 in block 1004. Energy is be accumulated in the transformer T₃.

In block 1006, a current threshold I_{THR1} is adjusted based on a current I_{L} flowing through the load 424. In one embodiment, if the current I_{L} increases higher than a predetermined value I_{PRE}, the current threshold I_{THR1} is decreased. If the current I_{L} decreases lower than the predetermined value I_{PRE}, the current threshold I_{THR1} is increased. In block 1008, if the output current I_{OUT1} is not higher than the current threshold I_{THR1}, the switch 414 remains on. Once the output current I_{OUT1} increases higher than the current threshold I_{THR1}, the controller 416 turns off the switch 414 to decouple the primary winding 404 from the power source in block 1010. An output current I_{OUT2} is conducted to flow from a secondary winding 410 of the transformer T₃ to the load and gradually decrease in block 1012. Energy stored in the transformer T₃ is transferred to the load. In block 1014, if the output current I_{OUT2} is not lower than a current threshold I_{THR2}, the switch 414 remains off. Once the output current I_{OUT2} decreases lower than the current threshold I_{THR2}, flowchart 1000 returns to block 1002 and the controller 416 turns on the switch 414 to couple the primary winding 404 to the power source.

Accordingly, embodiments in accordance with the present invention provide power converters and controllers for controlling power converters. The controller includes a first comparator operable for comparing a first sense signal indicative of an output current flowing through an energy storage component of the power converter with a first threshold and for generating a first comparison signal, and a second comparator operable for comparing a second sense signal indicative of the output current with a second threshold and for generating a second comparison signal. The controller further includes a control unit coupled to the first and second comparators and operable for turning a switch of the power convertor on and off according to the first and second comparison signals. When the controller turns on the switch, the energy storage component is coupled to a power source for storing energy from the power source. When the controller turns off the switch, the energy storage component is decoupled from the power source for releasing stored energy to a load.

In one embodiment, for a buck converter, if the first sense signal indicative of the output current flowing through the energy storage component decreases lower than the first threshold, the controller turns on the switch. If the second sense signal indicative of the output current flowing through the energy storage component increases higher than the second threshold, the controller turns off the switch. In another embodiment, for a flyback converter, the controller can generate and adjust the second threshold according to a current flowing through the load. If the load current increases higher than a predetermined value, the second threshold can be decreased accordingly. If the load current decreases lower than the predetermined value, the second threshold can be increased accordingly.

Additionally, although the present invention is described in conjunction with these embodiments, it will be understood that they are not intended to limit the invention to these embodiments and can be well suited to performing various other embodiments or variations of these embodiments.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A controller for controlling a power converter, comprising:
a first comparator operable for comparing a first sense signal indicative of an output current flowing through an energy storage component of said power converter with a first threshold and for generating a first comparison signal;
a second comparator operable for comparing a second sense signal indicative of said output current with a second threshold and for generating a second comparison signal; and
a control unit coupled to said first and second comparators and operable for turning on and off a switch of said power convertor according to said first and second comparison signals,
wherein said energy storage component is coupled to a power source for storing energy from said power source if said switch is turned on, and is decoupled from said power source for releasing stored energy to a load if said switch is turned off.

2. The controller of claim 1, further comprising:
an error amplifier operable for comparing a load current flowing through said load with a predetermined value and for generating said second threshold according to a corresponding comparison result.

3. The controller of claim 2, wherein said second threshold is decreased if said load current increases higher than said predetermined value, and is increased if said load current decreases lower than said predetermined value.

4. The controller of claim 1, wherein said control unit turns on said switch to couple said energy storage component to said power source if said first sense signal decreases lower than said first threshold, and turns off said switch to decouple said energy storage component from said power source if said second sense signal increases higher than said second threshold.

5. The controller of claim 1, wherein said energy storage component comprises a transformer having a primary winding and a secondary winding.

6. The controller of claim 5, wherein said first comparator coupled to said primary winding compares said first sense signal indicative of a first current flowing through said primary winding with said first threshold, and wherein said second comparator coupled to said secondary winding compares said second sense signal indicative of a second current flowing through said secondary winding with said second threshold.

7. A controller for controlling a power converter, comprising:
an input pin operable for receiving an input voltage of a power source coupled to said power converter;
a first sense pin coupled to an energy storage component of said power converter, wherein said controller receives a first sense signal indicative of an output current through said energy storage component by sensing a signal difference between said input pin and said first sense pin;
a second sense pin operable for receiving a second sense signal indicative of said output current; and
a control pin operable for generating a control signal to a switch coupled to said energy storage component to turn said switch on and off,
wherein said controller compares said first sense signal with a first threshold and generates a first comparison signal, wherein said controller compares said second sense signal with a second threshold and generates a second comparison signal, and wherein said controller generates said control signal to said switch via said control pin according to said first and second comparison signals.

8. The controller of claim 7, wherein said energy storage component is coupled to a power source for storing energy from said power source if said switch is turned on, and is decoupled from said power source for releasing stored energy to a load if said switch is turned off.

9. The controller of claim 7, further comprising:
an error amplifier operable for comparing a load current flowing through a load, which is coupled to said energy storage component, with a predetermined value and for generating said second threshold according to a corresponding comparison result.

10. The controller of claim 9, wherein said second threshold is decreased if said load current increases higher than said predetermined value, and is increased if said load current decreases lower than said predetermined value.

11. The controller of claim 7, wherein said controller turns on said switch to couple said energy storage component to said power source if said first sense signal decreases lower than said first threshold, and turns off said switch to decouple said energy storage component from said power source if said second sense signal increases higher than said second threshold.

12. The controller of claim 7, wherein said energy storage component comprises a transformer having a primary winding and a secondary winding.

13. The controller of claim 12, wherein said controller compares said first sense signal indicative of a first current flowing through said primary winding with said first threshold, and compares said second sense signal indicative of a second current flowing through said secondary winding with said second threshold.

14. A power converter comprising:
an energy storage component operable for storing energy from a power source and releasing stored energy to a load;
a switch operable for coupling said energy storage component to said power source and decoupling said energy storage component from said power source; and
a controller operable for turning said switch on and off according to an output current flowing through said energy storage component to control said output current within a predetermined range,
wherein said controller turns on said switch to couple said energy storage component to said power source if said output current decreases lower than a first current threshold, and turns off said switch to decouple said energy storage component from said power source if said output current increases higher than a second current threshold.

15. The power converter of claim 14, further comprising:
a diode coupled to said energy storage component and said load for conducting said output current flowing from said energy storage component to said load if said energy storage component is decoupled from said power source.

16. The power converter of claim 14, wherein said energy storage component comprises an inductor coupled between said power source and said load.

17. The power converter of claim 14, wherein said energy storage component comprises a transformer with a primary winding and a secondary winding.

18. The power converter of claim 17, wherein said controller compares a first sense signal indicative of a first current flowing through said primary winding with a first threshold, and compares a second sense signal indicative of a second current flowing through said secondary winding with a second threshold.

19. The power converter of claim 14, wherein said controller comprises:
a first comparator operable for comparing a first sense signal indicative of said output current with a first threshold and for generating a first comparison signal; and
a second comparator operable for comparing a second sense signal indicative of said output current with a second threshold and for generating a second comparison signal.

20. The power converter of claim 19, wherein said controller further comprises:
a control unit coupled to said first and second comparators and operable for turning on and off said switch according to said first and second comparison signals.

21. The power converter of claim 14, wherein said controller comprises an error amplifier operable for comparing a load current flowing through said load with a predetermined value and for generating said second current threshold according to a corresponding comparison result.

22. The power converter of claim 21, wherein said second current threshold is decreased if said load current increases higher than said predetermined value, and is increased if said load current decreases lower than said predetermined value.
